(19) United States
(12) Patent Application Publication
(10) Pub. No.: US 2011/0221211 A1
(43) Pub. Date: Sep. 15, 2011

(54) Self-Locking Latch for Window Sash

(76) Inventors: Corby Weron, Centerville, SD (US); Gavin Clark, Beresford, SD (US)

(21) Appl. No.: 13/043,727

(22) Filed: Mar. 9, 2011

Related U.S. Application Data
(60) Provisional application No. 61/312,001, filed on Mar. 9, 2010.

(51) Int. Cl. E05C 5/02; E05B 15/02; E05C 1/02

(52) U.S. Cl. 292/64; 292/138

(57) ABSTRACT

A window latch for a double hung window includes a housing and a tongue slidably engaged with the housing for moving between a retracted position and an extended position. A pivotable latch pivotably mounted within the housing releasably retains the tongue in the retracted position. As a window sash of the double hung window is lifted, a trigger slidably engaged with the housing pivots the pivotable latch so as to release the tongue from the retracted position.

### PRIORITY CLAIM

This application claims priority to and the benefit of U.S. Provisional Patent Application Ser. No. 61/312,001, filed on Mar. 9, 2010, the disclosure of which is hereby incorporated herein by reference in its entirety.

### TECHNICAL FIELD

This application relates to latches for windows and, more particularly, to self-locking latches for sliding window systems.

### BACKGROUND

A number of self-locking window latches are available on the market today. These include the model 4748 latch from Amesbury Group, Inc. (Amesbury, Mass.), the Prolatch latch from Interlock USA, Inc. (Reno, Nev.), the Autolock latch from Milgard Manufacturing, Inc. (Tacoma, Wash.), the I-Lock latch from Roto Frank AG (Leinfelden-Echterdingen, Germany), and the 19 Series Positive Action Lock latch from Truth Hardware (Owatonna, Minn.). Additionally, the Prolatch latch appears to be further described in U.S. Pat. No. 7,407,199, the disclosure of which is hereby incorporated by reference herein in its entirety. Several of the latches include components to restrain a latching tongue, that engages a separate keeper, in a retracted position. For example, the latching mechanism described in the '199 patent includes a cantilevered projection integral with the base of the latch. This integral projection projects upward from the base of the latch to engage a recess on the underside of the latch tongue when the tongue is moved to a retracted position. When contacted by an external element, such as the keeper, a release element forces the projection downward to release the tongue, which returns to an extended position (thereby positioned to engage the keeper). The exemplary latches also may utilize a retraction member, such as a button or lever that is a component separate from the latch cover itself, to retract the tongue. As the number of components increases, the associated parts and labor costs may also increase, along with the number of connections between the parts and associated reliability issues.

### SUMMARY OF THE INVENTION

Accordingly, there exists a need for a less complex, cost effective mechanism for self-locking windows that exhibits increased reliability and operational ease.

In one aspect, the invention relates to a window latch having a housing, a tongue slidably engaged with the housing for moving between a retracted position and an extended position, a pivotable latch pivotably mounted to the housing for releasably retaining the tongue in the retracted position, and a trigger slidably engaged with the housing for pivoting the pivotable latch so as to release the tongue from the retracted position.

In an embodiment of the above aspect, the window latch includes a spring for biasing the tongue into the extended position. In another embodiment, the window latch includes a retraction element for slidably moving the tongue from the extended position to the retracted position. In certain embodiments, the retraction element is a cover. In yet another embodiment, the pivotable latch pivots about an axis substantially orthogonal to the housing. In still another embodiment, the tongue has a sliding axis and the pivotable latch has a pivoting axis substantially orthogonal to the sliding axis.

In an embodiment of the above aspect, the pivotable latch pivots between a released position and a latched position in which the pivotable latch retains the tongue in the retracted position. In another embodiment, the spring is disposed between the tongue and the pivotable latch such that the spring biases the pivotable latch into the latched position. In another embodiment, the trigger slides between a first position and a second position, and when in the second position, the trigger pivots the pivotable latch from the latched position to the released position. In yet another embodiment, the trigger slides from the first position to the second position upon application of a force against a leading surface of the trigger. In still another embodiment, the window latch includes a keeper discrete from the housing, wherein the force against the leading surface of the trigger is applied by contact with the keeper.

In another aspect, the invention relates to a window latch having a housing having a first side housing surface, a second side housing surface, and a rear housing surface, a tongue slidably engaged with the housing for moving between a retracted position and an extended position, and a cover engaged with the tongue for moving the tongue from the extended position to the retracted position, wherein when the tongue is in at least one of the extended position and the refracted position, the cover substantially covers the first side housing surface, the second side housing surface, and the rear housing surface.

In an embodiment, the window latch further includes a latch mounted to the housing for releasably retaining the tongue in the retracted position. In another embodiment, the window latch includes a trigger slidably engaged with the housing for actuating the latch so as to release the tongue from the retracted position. In yet another embodiment, the latch is a pivotable latch pivotably mounted to the housing and the trigger is slidably engaged with the housing for pivoting the pivotable latch so as to release the tongue from the retracted position. In another embodiment, the cover is in a first vertical position when the tongue is in the retracted position and a second vertical position when the tongue is in the extended position. In still another embodiment, the first vertical position is higher than the second vertical position.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a schematic exploded view of a window latch in accordance with one embodiment of the invention;

FIG. 2A is a schematic partial top perspective view of the window latch depicted in FIG. 1, with a cover removed;

FIG. 2B is a schematic partial bottom perspective view of the window latch depicted in FIG. 2A when the latch is in a locked position;

FIG. 2C is a schematic partial bottom perspective view of the window latch depicted in FIG. 2B when the latch is in an unlocked position;

FIG. 2D is an enlarged schematic partial bottom perspective view of a single spring and trigger mechanism depicted in FIG. 2B;

FIGS. 3A and 3B are schematic partial top and bottom views of the spring and trigger mechanism depicted in FIG. 2D when the latch is in a locked position;

FIGS. 4A and 4B are schematic partial top and bottom views of the spring and trigger mechanism depicted in FIGS. 3A and 3B when the latch is in an unlocked position;

FIGS. 5A and 5B are schematic top and bottom perspective views of the window latch depicted in FIG. 1 when the latch is in an unlocked position;

FIGS. 6A and 6B are schematic top and bottom perspective views of the window latch depicted in FIGS. 5A and 5B when the latch is in a locked position;

FIG. 7A is a schematic side view of a window latch in a locked position in accordance with another embodiment of the invention;

FIG. 7B is a schematic side view of the window latch depicted in FIG. 7A when the latch is in an unlocked position;

FIG. 8A is a schematic partial perspective view of the window latch depicted in FIG. 7A without a cover;

FIG. 8B is a schematic top view of the window latch depicted in FIG. 8A; and

FIG. 8C is a schematic sectional view of the window latch along the line A-A depicted in FIG. 8B.

### DETAILED DESCRIPTION

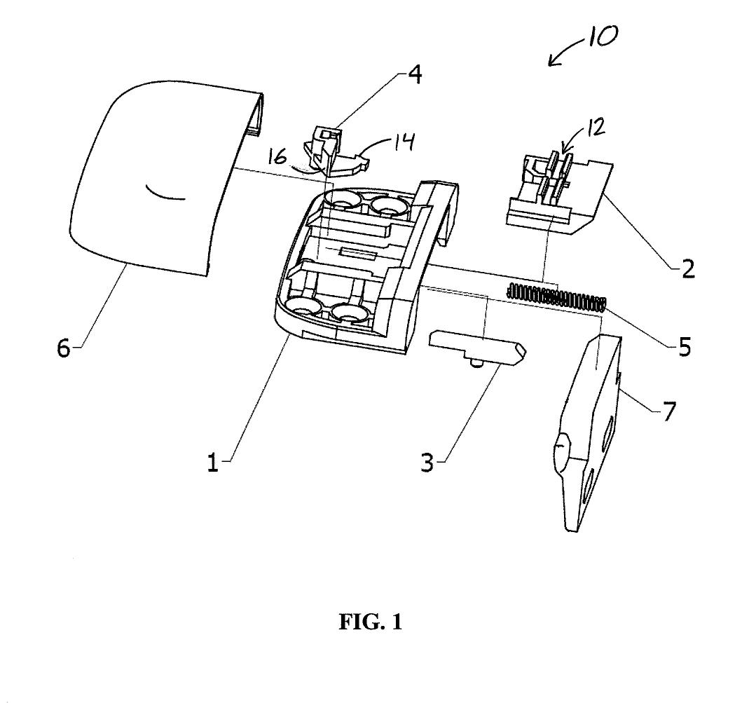

FIG. 1 depicts various components of a window latch 10. The latch 10 may include a lower housing 1 to act as a base for the various other elements. A tongue 2 may be slidably engaged with the lower housing 1, and may include a channel 12 for engaging a projection on the underside of a cover 6. A trigger 3 may be configured to slide independently of both the lower housing 1 and the tongue 2. A pivotable latch 4 may be pivotally engaged with the lower housing 1 and may include a hook 14 to engage a structure on the underside of the tongue 2 when the tongue 2 is in a retracted position, as well as an arm 16, as described in greater detail below. The spring 5 may simultaneously bias the tongue 2 in an extended position and the latch 4 in a latched position. The cover 6 may substantially cover and surround the lower housing 1 and the other internal components of the latch 10 and may be used to move the tongue 2 from the extended position to the retracted position. In other embodiments, a button discrete from the cover 6 may be used to retract the tongue 2. The keeper 7 may be mounted on a window sash opposite the lower housing 1 and may engage the tongue 2 when the tongue 2 is in the extended position.

The window latch 10 depicted in FIG. 1 has several advantages over the prior art. Using a single spring design may reduce the number of components, thereby reducing the final product cost, both in material and assembly costs. Labor costs may also be reduced because installing very small springs can be an intricate process that is further compounded when multiple springs are required. Additionally, using a cover 6 to cover many of the components and to act as the retraction element for the tongue 2 may both reduce cost and provide a very clean visual appearance of the window latch 10. Other advantages will be apparent to one of ordinary skill in the art.

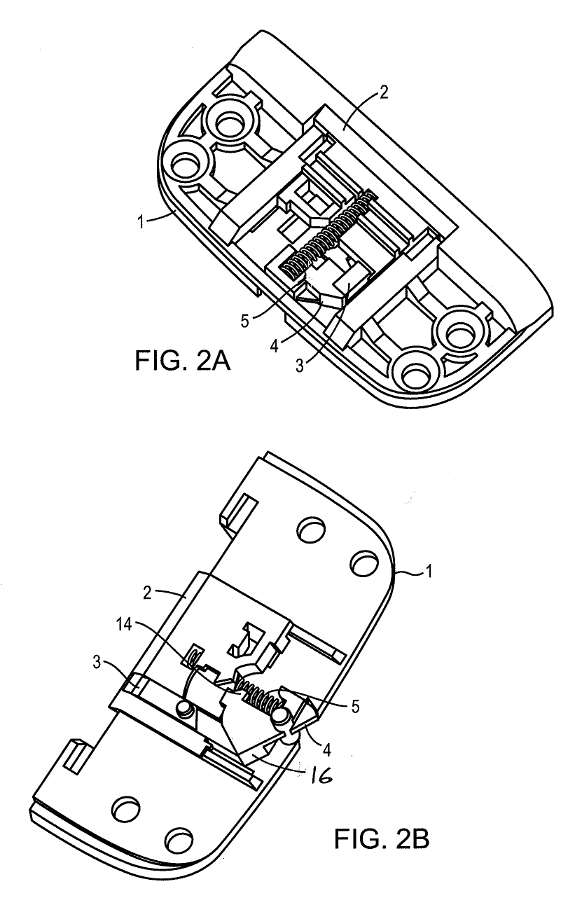

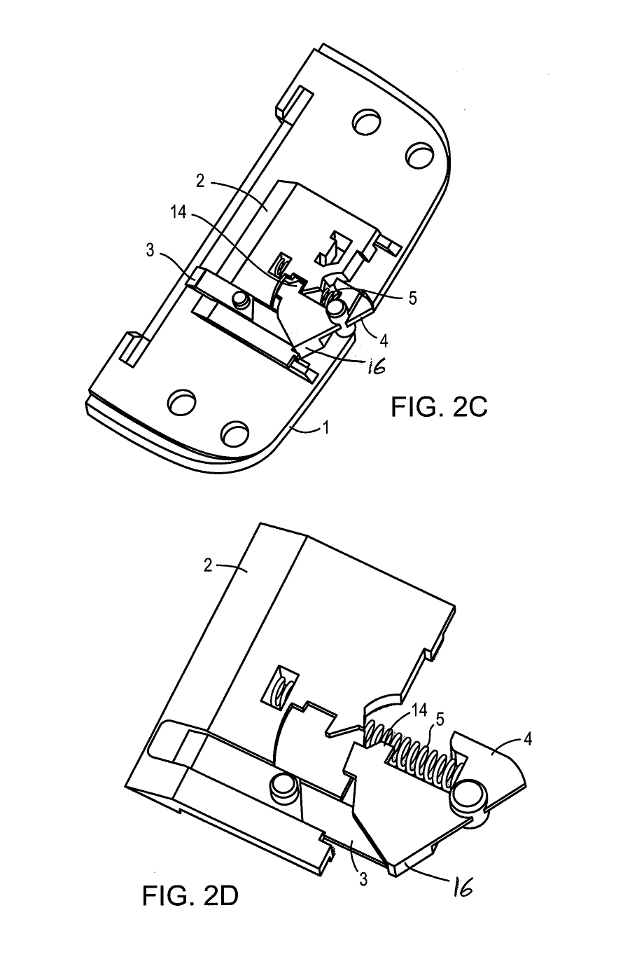

FIGS. 2A-2D depict components of the window latch 10 in both locked (i.e., tongue 2 extended) and unlocked (i.e., tongue 2 retracted) positions. For example, FIG. 2A depicts a schematic partial top perspective view of the latch in the locked position, i.e., when the tongue 2 is in the extended position. The tongue 2 may engage the keeper 7 when in the extended position to lock a window. FIG. 2B depicts a bottom perspective view of the latch 10 in the locked position. FIG. 2C depicts a bottom perspective view of the latch 10 in the unlocked position with the tongue 2 in the retracted position, being restrained by the pivotable latch 4. FIG. 2D depicts an enlarged partial bottom perspective view of the tongue 2 in the extended position, when the pivotable latch 4 is not engaged with the tongue 2.

The window latch 10 of the present invention may automatically lock a window when the window sash is closed. If the latch 10 begins with the tongue 2 restrained in the retracted position, a leading edge of the trigger 3 may project from the lower housing 1, as depicted in FIG. 2C. As the window sash is closed, the leading surface of the trigger 3 may contact the keeper 7, forcing the trigger 3 back into contact with the pivotable latch 4. This contact, in turn, may rotate or pivot the pivotable latch 4, which may have been holding the tongue 2 in the retracted position. As the pivotable latch 4 rotates, it may disengage from the tongue 2, permitting the tongue 2 and upper cover 6 to slide forward due to bias of the spring 5, so that the tongue 2 becomes engaged with the keeper 7. To open the window, an operator may retract the cover 6, and hold the cover 6 in the retracted position, until the window latch 10 has cleared the keeper 7. At this point, if the cover 6 is released by the operator, the cover 6 and tongue 2 may be held in place in the retracted position by the pivotable latch 4.

In an alternative method of opening the window sash, the operator may slide the cover 6 back into the retracted position, locking the tongue 2 in the retracted position, as before. The operator may release the cover 6 and then open the window sash. As the window sash is opened, the trigger 3 may contact the keeper 7, releasing the tongue 2 and cover 6 so that they slide forward to the locked position as the tongue 2 clears the keeper 7. A slightly different order of operations is also executed when closing the window sash. As the window is closed, the tongue 2 may contact the keeper 7, forcing the tongue 2 and cover 6 back. When the window is in the fully closed position, the tongue 2 and cover 6 may slide forward due to the bias of the spring 5, engaging the keeper 7.

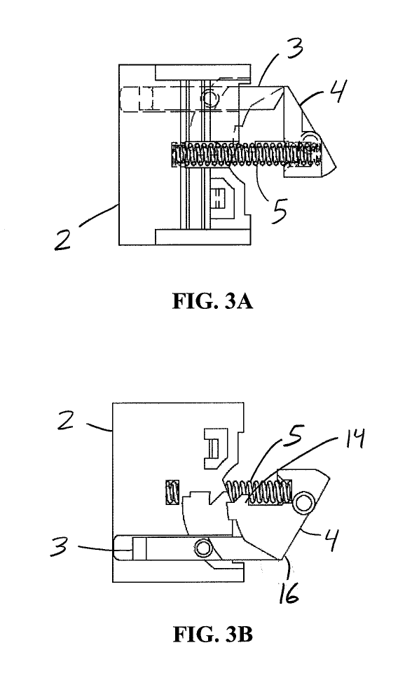

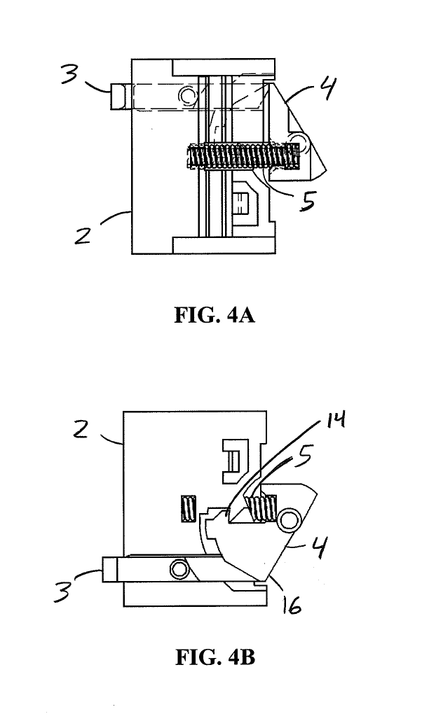

FIGS. 3A-4B depict the relationship between the tongue 2, trigger 3, pivotable latch 4, and spring 5. In FIGS. 3A and 3B, the window latch 10 is in the locked position. The tongue 2 projects forward of the trigger 3 (biased by the spring 5). Since the spring 5 is offset from the pivot axis of the pivotable latch 4, the spring 5 therefore biases the pivotable latch 4 in the latched position. As the tongue 2 is manually retracted (against the force of the spring 5), structure on the underside of the tongue 2 may contact the hook 14 of the pivotable latch 4, which engages with the structure, as depicted in FIGS. 4A and 4B. In this latched position, the pivotable latch 4 retains the tongue 2 in the retracted position. FIGS. 4A and 4B also depict a leading surface of the trigger 3 projecting beyond a forward edge of the tongue 2. When forced backwards (due to contact with the keeper 7), the trigger 3 may contact the arm 16 of the pivotable latch 4. This contact may pivot the pivotable latch 4 in the direction opposite that caused by the bias of the spring 5, which may cause the hook 14 to disengage with the structure on the underside of the tongue 2, thus allowing the spring 5 to bias the tongue 2 into the extended position depicted in FIGS. 3A and 3B.

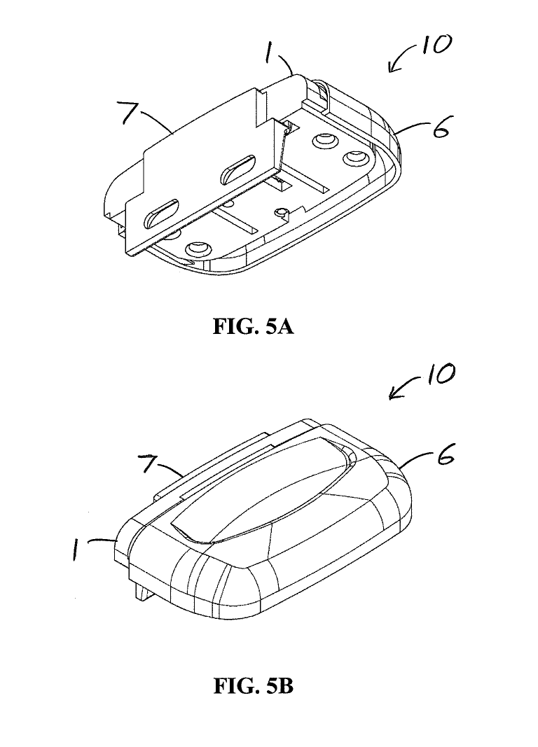

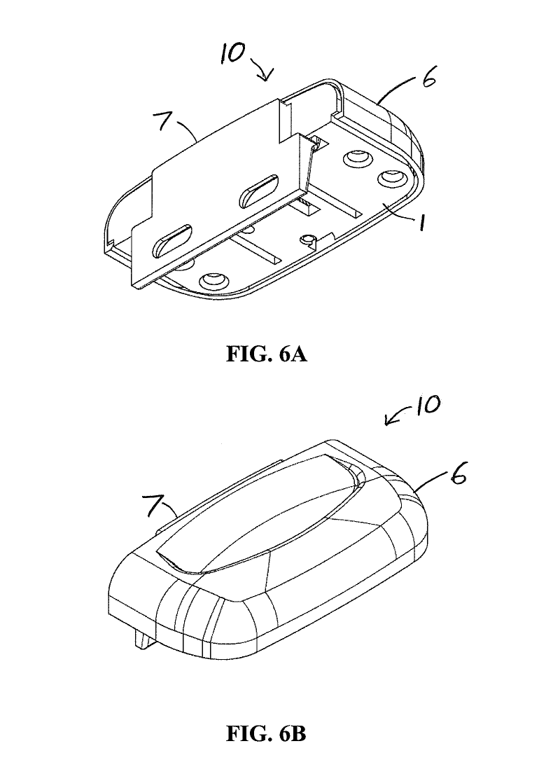

As described briefly above, the cover 6 of the window latch 10 may also function as the manual retraction element for the tongue 2. This reduces the number of components that must be manufactured and assembled, and helps maintain a smooth, aesthetically pleasing appearance, as depicted in the figures. FIGS. 5A and 5B depict the window latch 10 in the unlocked position (tongue 2 retracted), while FIGS. 6A and 6B depict the window latch 10 in the locked position (tongue 2 extended). In each position, the cover 6 may still encompass or surround substantially the entire lower housing 1, including a top, two side surfaces, and a rear surface. This helps the latch 10 to maintain an aesthetically pleasing appearance throughout operation.

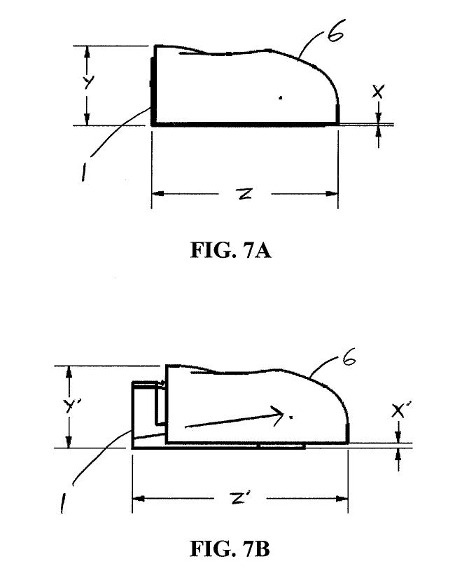

To help avoid interference between an edge of the cover 6 and another surface, such as the window sash, the cover 6 may lift slightly away from the window sash as it is retracted, as depicted in FIGS. 7A and 7B. In this embodiment, refraction of the cover 6 also causes the cover 6 to lift slightly, as represented by the differences between the dimensions X and Y in FIG. 7A and their corresponding dimensions X′ and Y′ in FIG. 7B. In one embodiment, the dimension X is approximately 0.01 inches and the dimension X′ is approximately 0.04 inches while the dimension Y is approximately 0.55 inches and the dimension Y′ is approximately 0.58 inches, meaning the cover 6 lifts approximately 0.03 inches when moving from the locked position to the unlocked position. In other embodiments, the dimension X may be as low as zero, though keeping the cover 6 above the lower surface of the lower housing 1 helps prevent the bottom edge of the cover 6 from sliding along the surface of the window sash cross rail, which might mar the surface or prevent smooth, reliable operation. In other embodiments, the dimension X may be greater, e.g., up to about 0.05 inches, or up to about 0.1 inches or greater. Horizontal movement of the cover 6 may be determined by the difference between the dimension Z (in one embodiment approximately 1.30 inches) and the dimension Z′ (in one embodiment approximately 1.52 inches), which may be approximately 0.22 inches. This movement may be as small as necessary to clear the tongue 2 of the keeper 7, for example 0.1 inches or less, or may be much larger to create a significant clearance between the tongue 2 in the retracted position and the keeper 7, for example 0.3 inches or greater. The dimensions mentioned above are not limiting and represent only a few embodiments of the window latch 10 of the present invention. Window latches having larger or smaller dimensions (or some mix thereof) are contemplated, as are window latches having covers that move distances other than those mentioned.

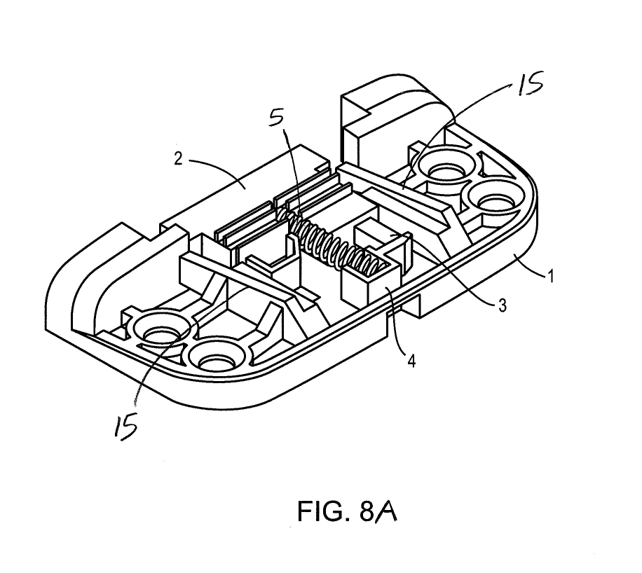

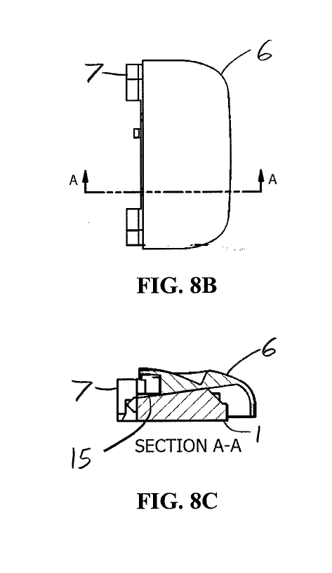

In order to achieve the lift of the edge of the cover 6 away from the surface of the window sash cross rail, the lower housing 1 may be manufactured with one or more internal ramp surfaces 15, as depicted in FIGS. 8A-8C. In this embodiment of the window latch 10, as the cover 6 is refracted, the cover 6 may translate or slide along the ramps 15 located on either side of the tongue 2, lifting slightly away from the lower housing 1 and, accordingly, away from the window sash cross rail. The tongue 2 may still retract horizontally, as in the embodiments described above. Accordingly, the projection on the underside of the cover 6 and the channel 12 on the tongue 2 may be configured to engage sufficiently such that contact between the two is not lost as the cover 6 retracts and lifts slightly.

The various components utilized in the window latches described herein may be metal and/or any type of polymer suitable for a particular application. Injection molded plastics are particularly desirable to reduce costs of fabrication. Polyurethane, polypropylene, PVC, PVDC, EVA, and others are contemplated for use. The spring may be made from stainless steel, to prevent failure associated with use. Other configurations and materials are contemplated. Additionally, the window latch disclosed herein may be utilized in a wide variety of window systems, such as sliding, single-hung, and double-hung windows.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A window latch comprising:
a housing;
a tongue slidably engaged with the housing for moving between a retracted position and an extended position;
a pivotable latch pivotably mounted to the housing for releasably retaining the tongue in the retracted position; and
a trigger slidably engaged with the housing for pivoting the pivotable latch so as to release the tongue from the retracted position.

2. The window latch of claim 1, further comprising a spring for biasing the tongue into the extended position.

3. The window latch of claim 1, further comprising a retraction element for slidably moving the tongue from the extended position to the retracted position.

4. The window latch of claim 3, wherein the retraction element comprises a cover.

5. The window latch of claim 1, wherein the pivotable latch pivots about an axis substantially orthogonal to the housing.

6. The window latch of claim 1, wherein the tongue comprises a sliding axis and the pivotable latch comprises a pivoting axis substantially orthogonal to the sliding axis.

7. The window latch of claim 1, wherein the pivotable latch pivots between a released position and a latched position in which the pivotable latch retains the tongue in the retracted position.

8. The window latch of claim 7, wherein the spring is disposed between the tongue and the pivotable latch such that the spring biases the pivotable latch into the latched position.

9. The window latch of claim 7, wherein the trigger slides between a first position and a second position, and wherein when in the second position, the trigger pivots the pivotable latch from the latched position to the released position.

10. The window latch of claim 9, wherein the trigger slides from the first position to the second position upon application of a force against a leading surface of the trigger.

11. The window latch of claim 10, further comprising a keeper discrete from the housing, wherein the force against the leading surface of the trigger is applied by contact with the keeper.

12. A window latch comprising:
a housing comprising a first side housing surface, a second side housing surface, and a rear housing surface;
a tongue slidably engaged with the housing for moving between a retracted position and an extended position; and
a cover engaged with the tongue for moving the tongue from the extended position to the retracted position, wherein when the tongue is in at least one of the extended position and the retracted position, the cover substantially covers the first side housing surface, the second side housing surface, and the rear housing surface.

13. The window latch of claim 12, further comprising a latch mounted to the housing for releasably retaining the tongue in the retracted position.

14. The window latch of claim 13, further comprising a trigger slidably engaged with the housing for actuating the latch so as to release the tongue from the retracted position.

15. The window latch of claim 14, wherein the latch comprises a pivotable latch pivotably mounted to the housing and the trigger is slidably engaged with the housing for pivoting the pivotable latch so as to release the tongue from the retracted position.

16. The window latch of claim 12, wherein the cover is in a first vertical position when the tongue is in the retracted position and a second vertical position when the tongue is in the extended position.

17. The window latch of claim 16, wherein the first vertical position is higher than the second vertical position.
